(19) United States
(12) Patent Application Publication
(10) Pub. No.: US 2022/0092550 A1
(43) Pub. Date: Mar. 24, 2022

(54) CONTACTLESS WORKPLACE ACCESS

(71) Applicant: CITRIX SYSTEMS, INC., Fort Lauderdale, FL (US)

(72) Inventors: ABHISHEK KUMAR ALAM, Pompano Beach, FL (US); Jayasree Beera, Pompano Beach, FL (US); Karan Jayant Dalvi, Pompano Beach, FL (US); Raymond Matthew Sampson, Coral Springs, FL (US)

(21) Appl. No.: 17/029,240

(22) Filed: Sep. 23, 2020

(51) Int. Cl. G06Q 10/10; G06K 19/06; G07C 9/32; G07C 9/37; H04W 4/021

(52) U.S. Cl. CPC G06Q 10/1095; G06K 19/06037; H04W 4/021; G07C 9/37; G07C 9/32

(57) ABSTRACT

A computing system includes an endpoint management server and a mobile device. The mobile device enrolls with the endpoint management server, and downloads a calendar app from the endpoint management server. The calendar app is used to schedule a meeting between a user of the mobile device and a host at a physical workplace. The endpoint management server is notified in response to the mobile device entering into a geo-fence of the physical workplace. The mobile device then receives an access code from the endpoint management server, and displays the access code to provide access by the user to the physical workplace.

### TECHNICAL FIELD

The present disclosure relates to computing systems, and more particularly, to a computing system for controlling access to a physical space.

### BACKGROUND

Enterprises and organizations provide physical workplaces for their employees. A physical workplace may be any of a variety of factory and office settings. Access to the physical workplace by visitors is typically controlled. Controlling access by visitors allows each visitor to be properly identified and recorded.

When a visitor arrives at a physical workplace, the visitor usually proceeds to a security desk to check in. After check in, an attendant at the security desk will notify an employee that is to meet with the visitor. This employee may be referred to as a host. The host then proceeds to the security desk to fill out a form to obtain an access pass for the visitor. The access pass allows the visitor to safely visit the physical workplace while accompanied by the host.

There are multiple person-to-person interactions in the above process between the attendant, the host and the visitor. Over the years there have been outbreaks of highly infectious diseases, such as H1N1, Ebola and COVIID-19. These diseases are contagious and easily transmitted. With the most recent outbreak of COVID-19, for example, social distancing guidelines were implemented.

Consequently, there is a need to reduce person-to-person interactions when granting access by a visitor to a physical workplace in order to adhere to social distancing guidelines. Also, there is a need to reduce the number of touch points (e.g., touching a pen, form, etc.) since these touch points have potential for virus transmission.

### SUMMARY

A mobile device includes a memory and a processor coupled to the memory. The processor enrolls the mobile device with an endpoint management server, and downloads a calendar app from the endpoint management server. The calendar app is used to schedule a meeting between a user of the mobile device and a host at a physical workplace. The processor notifies the endpoint management server in response to the mobile device entering into a geo-fence of the physical workplace, and receives from the endpoint management server an access code. The access code is displayed by the processor to provide access by the user to the physical workplace.

The processor may be further configured to receive an invite from the endpoint management server to initiate the enrollment of the mobile device with the endpoint management server.

The calendar app may comprise a containerized calendar app under control of the endpoint management server. Control of the containerized calendar app may include the endpoint management server at least partially enabling and disabling the containerized calendar app based on a geo-location of the mobile device with respect to the geo-fence of the physical workplace.

The processor may be further configured to receive a geo-fence policy from the endpoint management server, with the geo-fence policy providing boundaries of the geo-fence of the physical workplace.

The processor may be further configured to determine a current geo-location of the mobile device, and compare the current geo-location of the mobile device to the geo-fence of the physical workplace to determine that the mobile device has entered into the geo-fence.

The access code may be received by the processor after the endpoint management server validates that the user is at the physical workplace on a scheduled day and time for the meeting.

The processor may be further configured to use biometrics of the user to authenticate the user with the endpoint management server before displaying the access code. The access code may be a QR code or an animated QR code, for example.

Another aspect is directed to a method for operating the above described mobile device. The method comprises enrolling the mobile device with an endpoint management server, and downloading a calendar app from the endpoint management server. The calendar app is be used to schedule a meeting between a user of the mobile device and a host at a physical workplace. The endpoint management server is notified in response to the mobile device entering into a geo-fence of the physical workplace. The mobile device receives from the endpoint management server an access code, and displays the access code to provide access by the user to the physical workplace.

Another aspect is directed to an endpoint management server comprising a memory and a processor coupled to the memory. The processor is to enroll a mobile device, and provide a calendar app to the mobile device. The calendar app is used to schedule a meeting between a user of the mobile device and a host at a physical workplace. The processor receives notification that the mobile device has entered into a geo-fence of the physical workplace, and provides an access code to the mobile device. The processor grants access by the user to the physical workplace based on display of the access code.

Another aspect is directed to a method for operating the above described endpoint management server. The method comprises enrolling a mobile device, and providing a calendar app to the mobile device. The calendar app is used to schedule a meeting between a user of the mobile device and a host at a physical workplace. Notification is received that the mobile device has entered into a geo-fence of the physical workplace, and an access code is provided to the mobile device. Access by the user to the physical workplace is granted based on display of the access code.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of an enterprise mobility management system in which various aspects of the disclosure may be implemented.

FIG. 7 is a schematic block diagram of a computing system providing contactless workplace access to a visitor at a physical workplace in which various aspects of the disclosure may be implemented.

FIG. 8 is a sequence diagram on providing the contactless workplace access to the visitor for the computing system illustrated in FIG. 7.

FIG. 9 is a flowchart illustrating a method for operating the mobile device illustrated in FIG. 7.

FIG. 10 is a flowchart illustrating a method for operating the endpoint management server illustrated in FIG. 7.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout, and prime notation is used to indicate similar elements in different embodiments.

Physical workplaces for enterprises and organizations often receive visitors. Controlling access by visitors allows each visitor to be properly identified and recorded. The current workflow process for receiving a visitor involves multiple person-to-person interactions, as well as physical touch points. The current workflow process is susceptible to the spread of highly infectious diseases during an outbreak.

A computing system is provided to reduce or eliminate person-to-person interactions and physical touch points in the workplace access for visitors. As will be described in more detail below, workplace access for visitors will be contactless, and more secure by using user biometrics to obtain an entry code without having to disclose the user biometrics to the system. The entry code is equivalent to an ID card. In addition, the entry code may be time and location. sensitive. Also, the system. will be fast and efficient by allowing the entry code to be generated on demand.

The techniques and teachings of the present disclosure provide contactless workplace access by visitors to a physical workplace. This enables person-to-person interactions and physical touch points to be reduced or eliminated which help to reduce the chance of spreading highly infectious diseases during an outbreak.

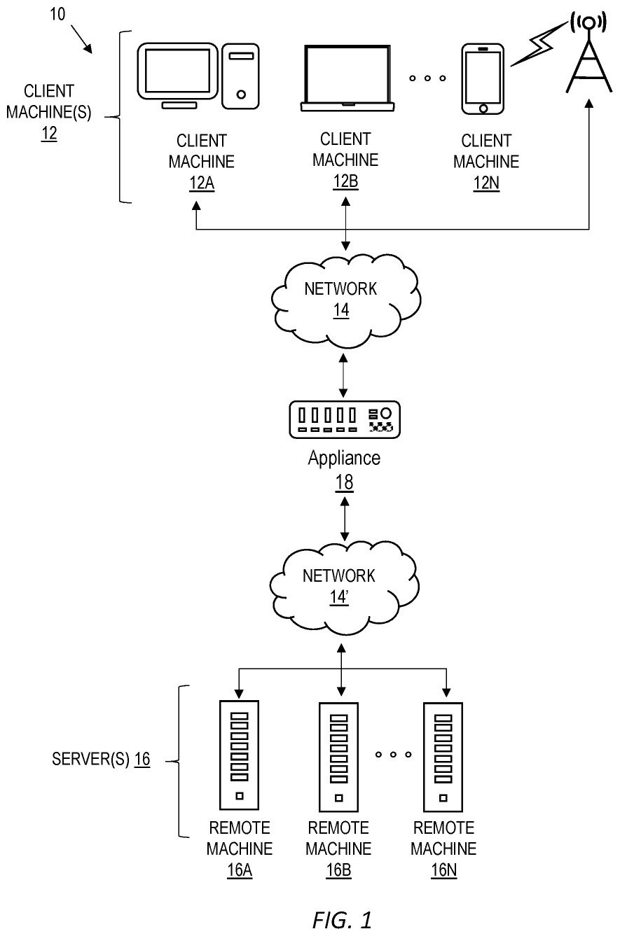

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 18 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

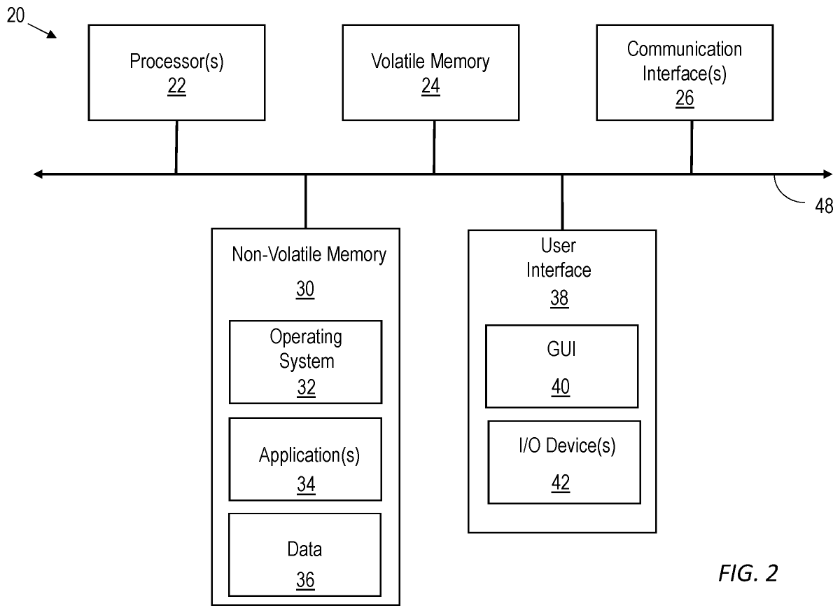

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Fla. (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

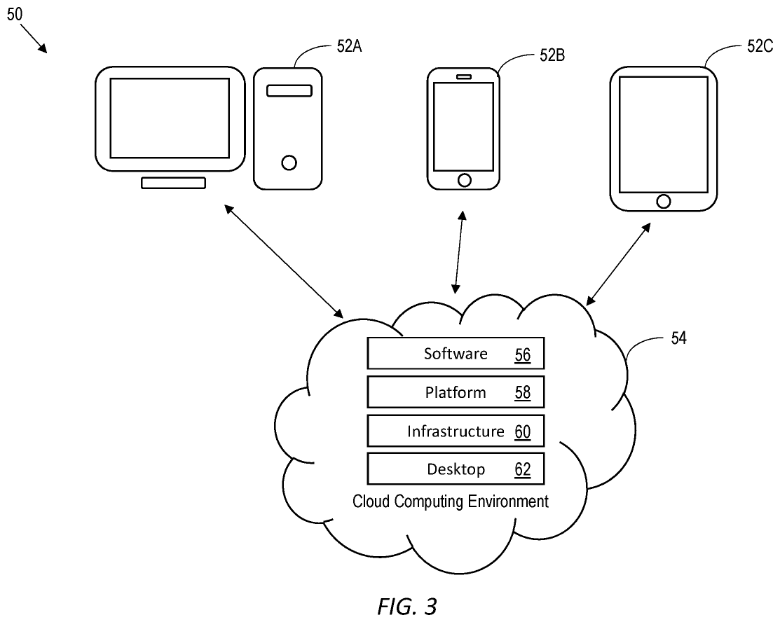

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, California, or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft ONEDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

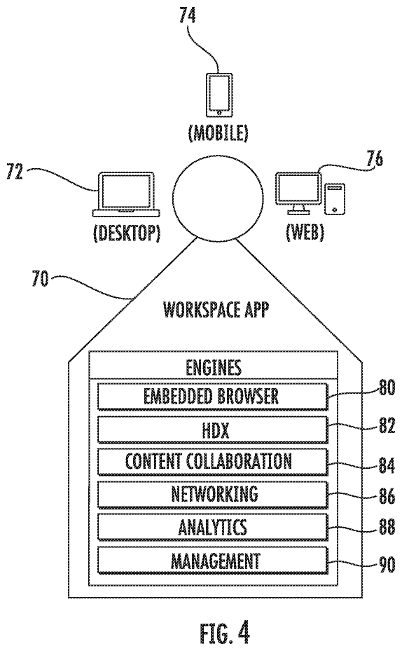

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

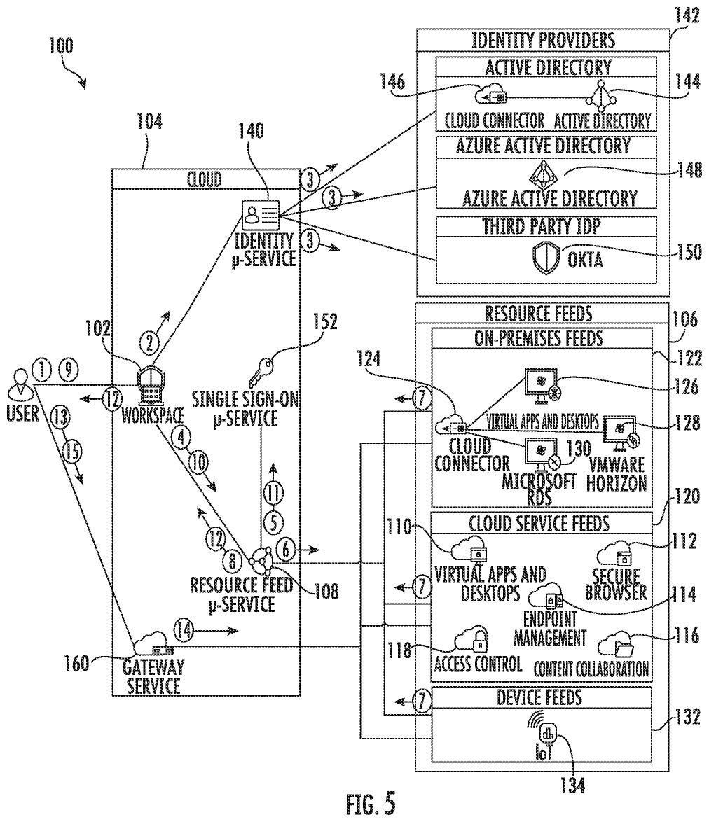

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

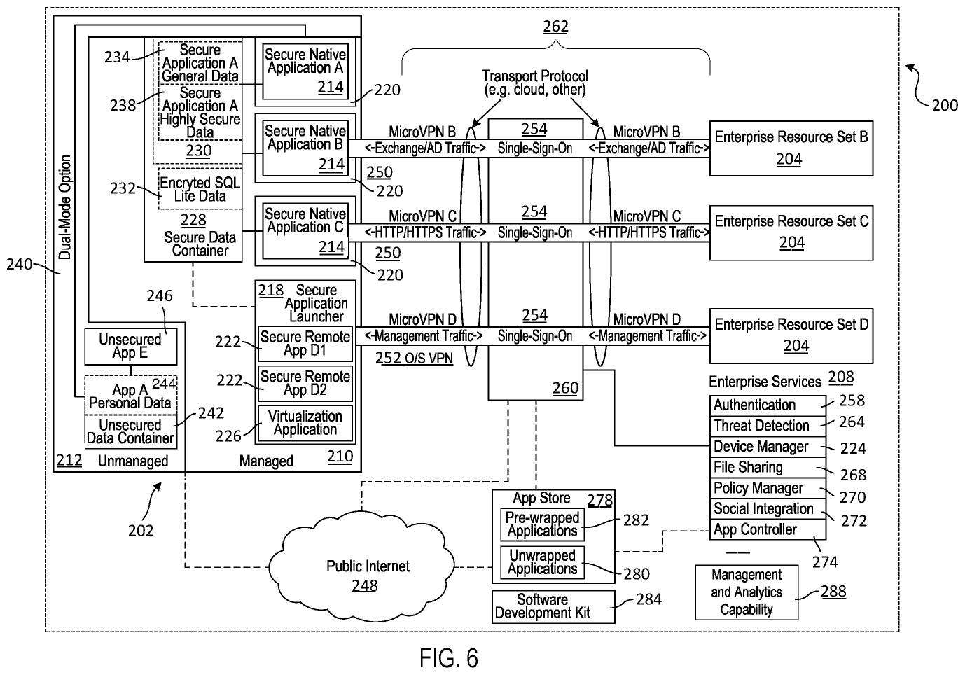

FIG. 6 represents an enterprise mobility technical architecture 200 for use in a Bring Your Own Device (BYOD) environment. The architecture enables a user of a mobile device 202 to both access enterprise or personal resources from a mobile device 202 and use the mobile device 202 for personal use. The user may access such enterprise resources 204 or enterprise services 208 using a mobile device 202 that is purchased by the user or a mobile device 202 that is provided by the enterprise to the user. The user may utilize the mobile device 202 for business use only or for business and personal use. The mobile device 202 may run an iOS operating system, an Android operating system, or the like.

The enterprise may choose to implement policies to manage the mobile device 202. The policies may be implemented through a firewall or gateway in such a way that the mobile device 202 may be identified, secured or security verified, and provided selective or full access to the enterprise resources (e.g., 204 and 208.) The policies may be mobile device management policies, mobile application management policies, mobile data management policies, or some combination of mobile device, application, and data management policies. A mobile device 202 that is managed through the application of mobile device management policies may be referred to as an enrolled device.

In some embodiments, the operating system of the mobile device 202 may be separated into a managed partition 210 and an unmanaged partition 212. The managed partition 210 may have policies applied to it to secure the applications running on and data stored in the managed partition 210. The applications running on the managed partition 210 may be secure applications. In other embodiments, all applications may execute in accordance with a set of one or more policy files received separate from the application, and which define one or more security parameters, features, resource restrictions, and/or other access controls that are enforced by the mobile device management system when that application is executing on the mobile device 202.

By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 214, secure remote applications 222 executed by a secure application launcher 218, virtualization applications 226 executed by a secure application launcher 218, and the like.

The secure native applications 214 may be wrapped by a secure application wrapper 220. The secure application wrapper 220 may include integrated policies that are executed on the mobile device 202 when the secure native application 214 is executed on the mobile device 202. The secure application wrapper 220 may include meta-data that points the secure native application 214 running on the mobile device 202 to the resources hosted at the enterprise (e.g., 204 and 208) that the secure native application 214 may require to complete the task requested upon execution of the secure native application 214.

The secure remote applications 222 executed by a secure application launcher 218 may be executed within the secure application launcher 218. The virtualization applications 226 executed by a secure application launcher 218 may utilize resources on the mobile device 202, at the enterprise resources 204, and the like. The resources used on the mobile device 202 by the virtualization applications 226 executed by a secure application launcher 218 may include user interaction resources, processing resources, and the like.

The user interaction resources may be used to collect and transmit keyboard input, mouse input, camera input, tactile input, audio input, visual input, gesture input, and the like. The processing resources may be used to present a user interface, process data received from the enterprise resources 204, and the like. The resources used at the enterprise resources 204 by the virtualization applications 226 executed by a secure application launcher 218 may include user interface generation resources, processing resources, and the like.

The user interface generation resources may be used to assemble a user interface, modify a user interface, refresh a user interface, and the like. The processing resources may be used to create information, read information, update information, delete information, and the like. For example, the virtualization application 226 may record user interactions associated with a graphical user interface (GUI) and communicate them to a server application where the server application will use the user interaction data as an input to the application operating on the server.

In such an arrangement, an enterprise may elect to maintain the application on the server side as well as data, files, etc. associated with the application. While an enterprise may elect to “mobilize” some applications in accordance with the principles herein by securing them for deployment on the mobile device 202, this arrangement may also be elected for certain applications. For example, while some applications may be secured for use on the mobile device 202, others might not be prepared or appropriate for deployment on the mobile device 202 so the enterprise may elect to provide the mobile user access to the unprepared applications through virtualization techniques.

As another example, the enterprise may have large complex applications with large and complex data sets (e.g., material resource planning applications) where it would be very difficult, or otherwise undesirable, to customize the application for the mobile device 202 so the enterprise may elect to provide access to the application through virtualization techniques.

As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data.

An enterprise may elect to provide both fully secured and fully functional applications on the mobile device 202 as well as a virtualization application 226 to allow access to applications that are deemed more properly operated on the server side. In an embodiment, the virtualization application 226 may store some data, files, etc. on the mobile device 202 in one of the secure storage locations. An enterprise, for example, may elect to allow certain information to be stored on the mobile device 202 while not permitting other information.

In connection with the virtualization application 226, as described herein, the mobile device 202 may have a virtualization application 226 that is designed to present GUIs and then record user interactions with the GUI. The virtualization application 226 may communicate the user interactions to the server side to be used by the server side application as user interactions with the application. In response, the application on the server side may transmit back to the mobile device 202 a new GUI. For example, the new GUI may be a static page, a dynamic page, an animation, or the like, thereby providing access to remotely located resources.

The secure applications 214 may access data stored in a secure data container 228 in the managed partition 210 of the mobile device 202. The data secured in the secure data container may be accessed by the secure native applications 214, secure remote applications 222 executed by a secure application launcher 218, virtualization applications 226 executed by a secure application launcher 218, and the like.

The data stored in the secure data container 228 may include files, databases, and the like. The data stored in the secure data container 228 may include data restricted to a specific secure application 230, shared among secure applications 232, and the like. Data restricted to a secure application may include secure general data 234 and highly secure data 238. Secure general data may use a strong form of encryption such as Advanced Encryption Standard (AES) 128-bit encryption or the like, while highly secure data 238 may use a very strong form of encryption such as AES 256-bit encryption.

Data stored in the secure data container 228 may be deleted from the mobile device 202 upon receipt of a command from the device manager 224. The secure applications (e.g., 214, 222, and 226) may have a dual-mode option 240. The dual mode option 240 may present the user with an option to operate the secured application in an unsecured or unmanaged mode. In an unsecured or unmanaged mode, the secure applications may access data stored in an unsecured data container 242 on the unmanaged partition 212 of the mobile device 202. The data stored in an unsecured data container may be personal data 244. The data stored in an unsecured data container 242 may also be accessed by unsecured applications 246 that are running on the unmanaged partition 212 of the mobile device 202. The data stored in an unsecured data container 242 may remain on the mobile device 202 when the data stored in the secure data container 228 is deleted from the mobile device 202.

An enterprise may want to delete from the mobile device 202 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device 202 may connect to enterprise resources 204 and enterprise services 208 at an enterprise, to the public Internet 248, and the like. The mobile device 202 may connect to enterprise resources 204 and enterprise services 208 through virtual private network connections. The virtual private network connections, also referred to as microVPN or application-specific VPN, may be specific to particular applications (as illustrated by microVPNs 250, particular devices, particular secured areas on the mobile device (as illustrated by O/S VPN 252), and the like. For example, each of the wrapped applications in the secured area of the mobile device 202 may access enterprise resources through an application specific VPN such that access to the VPN would be granted based on attributes associated with the application, possibly in conjunction with user or device attribute information.

The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 254. The single-sign-on processes may allow a user to provide a single set of authentication credentials, which are then verified by an authentication service 258. The authentication service 258 may then grant to the user access to multiple enterprise resources 204, without requiring the user to provide authentication credentials to each individual enterprise resource 204.

The virtual private network connections may be established and managed by an access gateway 260. The access gateway 260 may include performance enhancement features that manage, accelerate, and improve the delivery of enterprise resources 204 to the mobile device 202. The access gateway 260 may also re-route traffic from the mobile device 202 to the public Internet 248, enabling the mobile device 202 to access publicly available and unsecured applications that run on the public Internet 248. The mobile device 202 may connect to the access gateway via a transport network 262. The transport network 262 may use one or more transport protocols and may be a wired network, wireless network, cloud network, local area network, metropolitan area network, wide area network, public network, private network, and the like.

The enterprise resources 204 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 204 may be premise-based resources, cloud-based resources, and the like. The enterprise resources 204 may be accessed by the mobile device 202 directly or through the access gateway 260. The enterprise resources 204 may be accessed by the mobile device 202 via the transport network 262.

The enterprise services 208 may include authentication services 258, threat detection services 264, device manager services 224, file sharing services 268, policy manager services 270, social integration services 272, application controller services 274, and the like. Authentication services 258 may include user authentication services, device authentication services, application authentication services, data authentication services, and the like.

Authentication services 258 may use certificates. The certificates may be stored on the mobile device 202, by the enterprise resources 204, and the like. The certificates stored on the mobile device 202 may be stored in an encrypted location on the mobile device 202, the certificate may be temporarily stored on the mobile device 202 for use at the time of authentication, and the like. Threat detection services 264 may include intrusion detection services, unauthorized access attempt detection services, and the like. Unauthorized access attempt detection services may include unauthorized attempts to access devices, applications, data, and the like.

Device management services 224 may include configuration, provisioning, security, support, monitoring, reporting, and decommissioning services. File sharing services 268 may include file management services, file storage services, file collaboration services, and the like. Policy manager services 270 may include device policy manager services, application policy manager services, data policy manager services, and the like.

Social integration services 272 may include contact integration services, collaboration services, integration with social networks such as Facebook, Twitter, and LinkedIn, and the like. Application controller services 274 may include management services, provisioning services, deployment services, assignment services, revocation services, wrapping services, and the like.

The enterprise mobility technical architecture 200 may include an application store 278. The application store 278 may include unwrapped applications 280, pre-wrapped applications 282, and the like. Applications may be populated in the application store 278 from the application controller 274. The application store 278 may be accessed by the mobile device 202 through the access gateway 260, through the public Internet 248, or the like. The application store 278 may be provided with an intuitive and easy to use user interface.

A software development kit 284 may provide a user the capability to secure applications selected by the user by wrapping the application as described previously in this description. An application that has been wrapped using the software development kit 284 may then be made available to the mobile device 202 by populating it in the application store 278 using the application controller 274.

The enterprise mobility technical architecture 200 may include a management and analytics capability 288. The management and analytics capability 288 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

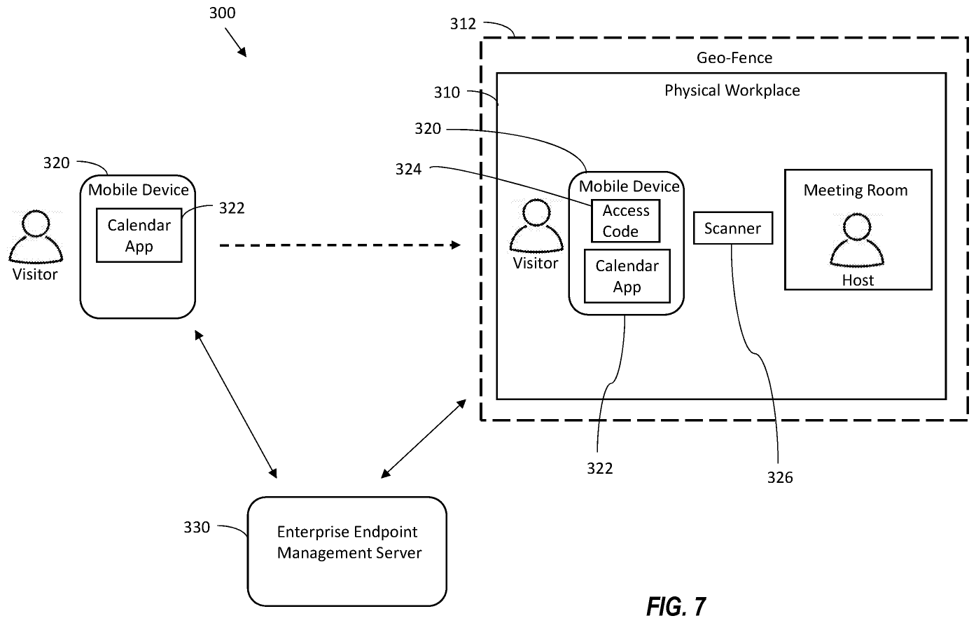

Referring now to FIG. 7, the illustrated computing system 300 provides contactless workplace access by visitors to a physical workplace 310 within an enterprise or organization. The physical workplace 310 may be a factory or office building, for example. An employee within the physical workplace 310 may have the need to meet with a visitor that does not have access to the physical workplace 310. In some case, the visitor may be an employee that does not have access to the physical workplace 310. Even though the illustrated computing system 300 is discussed in terms of workplace access, the use of workspace is not to be limiting. Access as discussed below may be any physical space.

As will be discussed in greater detail below, the computing system 300 includes an enterprise endpoint management server 330 that downloads a calendar app 322 to the visitor's mobile device 320. The calendar app 322 allows a meeting to be scheduled between the employee (i.e., host) and the visitor. The endpoint management server 330 establishes a geo-fence (i.e., a virtual perimeter) 312 at the physical workplace 310. The calendar app 322 is configured to access a map app on the mobile device 320, such as Google Maps, to determine a geo-location location of the mobile device 320 with respect to the geo-fence 312. The calendar app 322 notifies the endpoint management server 330 when the visitor enters the geo-fence 312.

After the endpoint management server 330 validates the scheduled meeting with the host, an access code 324 is provided by the endpoint management server 330 to the visitor's mobile device 320. For the visitor to display the access code 324 within the geo-fence 312, biometrics are used to authenticate the visitor. After visitor authentication, the access code 324 may then be scanned and validated at the physical workplace 310 to grant access by the visitor to meet with the host.

The computing system 300 advantageously provides contactless workplace access by a visitor to a physical workplace 310. Contactless workplace access enables person-to-person interactions and physical touch points to be reduced or elimated, which help to reduce the chance of a highly infectious disease, such as Covid-19, from being spread during an outbreak.

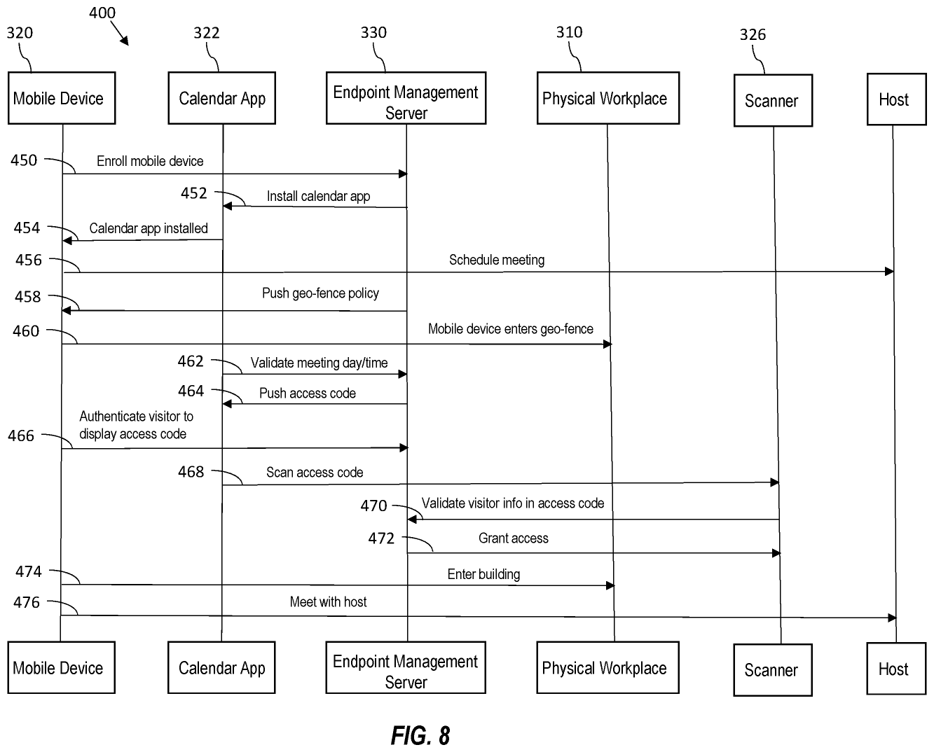

A sequence diagram 400 on providing the contactless workplace access to the visitor will now be discussed in reference to FIG. 8. Before the host can schedule the meeting with the visitor, the visitor needs to enroll their mobile device 320 with the enterprise endpoint management server 330 at line 450. The endpoint management server 330 manages device and app policies for an enterprise or organization, and delivers apps to users enrolled with the endpoint management server 330. The apps may be from an app store, which may be on-premises or cloud-based.

The endpoint management server 330 is not limited to any particular architecture. For example, the endpoint management server 330 may be based on the endpoint management service architecture 114 as shown in FIG. 5 within a workspace network environment 100. In other configurations, the endpoint management server 330 may be based the mobile device management service architecture 200 as shown in FIG. 6.

As part of the enrollment process, the visitor receives a notification for a calendar app 322 to be installed on their mobile device 320. The notification may be sent to the visitor via email or text, for example. The enrollment is initiated by the host. If the visitor accepts, the visitor provides a user name and password, for example, to enroll the mobile device 320, and then the endpoint management server 330 provides an install app command to the app store at line 452. The calendar app 322 is downloaded from the app store to the mobile device 320 at line 454.

After enrollment, the meeting between the visitor and host is scheduled for a particular day and time using the calendar app 322 at line 456. The calendar app 322 is to be under control of the enterprise endpoint management server 330, and may be referred to as a containerized calendar app.

The calendar app 322 may be a standalone app or part of the workspace app 70 as discussed above in reference to FIGS. 4 and 5. The workspace app 70 is used as a single-entry point for bringing apps, files and desktops together (whether on-premises or in the cloud) to deliver a unified experience. The calendar app 322 is different from a calendar associated with an email program installed on the mobile device 320. The calendar associated with an email program, such as Outlook, is not under control of the endpoint management server 330.

Control of the calendar app 322 includes the endpoint management server 330 at least partially enabling and disabling the containerized calendar app 322 based on a geo-location of the mobile device 320 with respect to the geo-fence 312 of the physical workplace 310. For instance, a portion of the calendar app 322 may be enabled to allow the visitor to see the scheduled meeting day and time, without restrictions, once scheduled with the host. However, a portion of the calendar app 322 may be disabled so that the access code 324 needed by the visitor to access the physical workplace 312 is not available for display until the visitor has entered the geo-fence 312 of the physical workplace 310 and has been authenticated using biometrics at the mobile device 320.

Control of the calendar app 322 includes the endpoint management server 330 pushing a geo-fence policy to the mobile device 320 at line 458. The geo-fence policy includes the coordinates of the geo-fence 312. Control of the calendar app 322 also includes the endpoint management server 330 pushing notifications to the visitor when the visitor is within the geo-fence 312 of the physical workplace 310 on the day of the scheduled meeting.

The mobile device 320 includes a processor to determine a current geo-location of the mobile device 320, and hence the visitor. The processor cooperates with the calendar app 322 to compare the current geo-location to the geo-fence 312 of the physical workplace 310 to determine at line 460 that the mobile device (and hence the visitor) has entered into the geo-fence 310.

The current geo-location of the mobile device 320 may be based on the calendar app 322 accessing a map app on the mobile device 320. The map app may be Google Maps, for example. In other configurations, the calendar app 322 may access a GPS tracking system within the mobile device 320 to determine the current geo-location of the mobile device 320.

Prior to the endpoint management server 330 being notified that the mobile device 320 has entered the geo-fence 312, the calendar app 322 validates the day and time of the scheduled meeting. The calendar app 322 compares the current day and time to the scheduled meeting day and time to determine if the scheduled meeting is about to begin. If the meeting is about to begin and the visitor is within the geo-fence 312, then the calendar app 322 notifies the enterprise endpoint management server 330 at line 462 that the visitor is at the right place at the right time for the scheduled meeting.

If the visitor arrives too early for the scheduled meeting, the endpoint management server 330 may not be notified until a predetermined time before the meeting start time has been met. For example, there may be a 30 minute window prior to the start of the scheduled meeting time on when the calendar app 322 will notify the enterprise endpoint management server 330 that the visitor is within the geo-fence 312 at the right time for the scheduled meeting.

After the scheduled meeting has been validated by the calendar app 322, the endpoint management server 330 pushes a notification to the calendar app 322 asking if the visitor wants to receive the access code 324 needed to enter the physical workplace 310. In response to the visitor accepting the access code 324, the endpoint management server 330 pushes the access code 324 to the calendar app 322 at line 464.

The access code 322 is time sensitive and needs to be used within the validity period. The access code 322 may provide information on name of the visitor and host, meeting time and meeting location. The information may be in the form of a QR code or an animated QR code, for example. With the information being embedded within the QR code or the animated QR code, the information is not perceptible to the human eye. As readily appreciated by those skilled in the art, the access code 322 is not limited to QR codes or animated QR codes. The access code 322 may be provided in other forms, such as a bar code, graphics or an alphanumeric sequence, for example.

According to some embodiments, before the access code 322 is to be displayed on the mobile device 320, the visitor needs to be authenticated at line 466. Authentication of the visitor may be performed using biometrics. Biometrics include finger print recognition and facial recognition, for example. With biometrics, the visitor authentication is secure in that the endpoint management server 330 does not receive the biometrics. Instead, the mobile device communicates to the endpoint management server 330 that the visitor has been authenticated. As an alternative to biometrics, authentication may be performed where a user name and password is provided to the endpoint management server 330.

Visitor authentication verifies that the mobile device 320 from which the visitor has requested the access code is an enrolled device with the enterprise endpoint management server 330. Further, the current day and time can be used to determine whether the visitor should be issued a valid access code 324.

After the visitor has successfully authenticated, the access code 324 is then displayed on the mobile device 320. The visitor may then scan at line 468 the access code 324 at a scanner 326. The scanner 326 may be at an entry point, e.g., door, into the physical workplace 310. After the scanner validates the information embedded within the access code 324 at line 470, access to the physical workplace 310 is granted to the visitor at line 472.

The use of a scanner to read the access code 324 eliminates a physical touch point as you would have with a keypad, for example. This help to reduce the chance of spreading highly infectious diseases during an outbreak. However, in alternative configurations, a physical touch point may be used to grant access to the visitor. The visitor enters the building at line 474, and meets with the host at line 476.

With the computing system 300 as described above, functionality provided by the endpoint management server 330 and biometrics received by the mobile device 320 are leveraged to allow access to authorized visitors. The computing system 300 makes use of biometrics without requiring details of the user's biometrics to leave the mobile device 320. As the endpoint management server 330 has access to the user's registered mobile device 320 information, the endpoint management server 330 will not allow the visitor to generate an access code 324 from a different device.

The use of biometrics in combination with the QR code or the animated QR code acts as a multi-factor authentication. Further, geo-location of the mobile device 320 with respect to the geo-fence 312 of the physical workplace 310 helps to prevent the visitor from generating a valid access code 324 when they are not near the physical workplace 310. Further, a valid code cannot be generated and used it at a later point in time as it time sensitive.

The computing system 300 as described above is directed to granting physical access to a visitor at a physical workplace 310. The visitor is to attend a meeting being hosted by an employee at the physical workplace 310, for example. As readily appreciate by those skilled in the art, a generic solution can also be extended to address employee's workplace access. In this case, the computing system 300 would serve as a security enhancement compared to the physical ID card scanning.

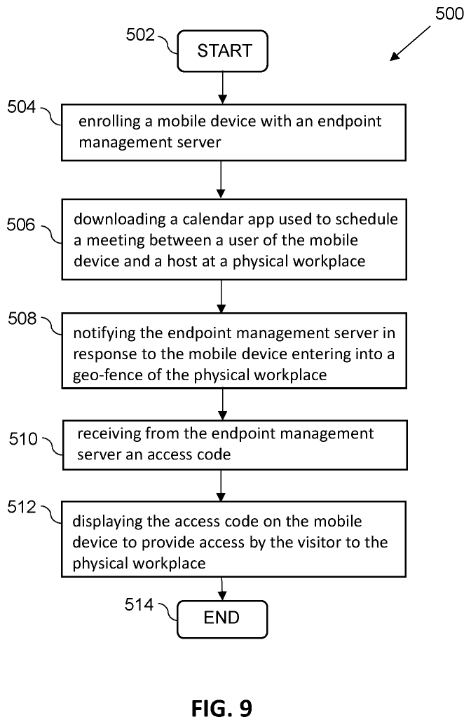

Referring now to FIG. 9, a flowchart 500 illustrating a method for operating the mobile device 320 will be discussed. From the start (Block 502), the method includes enrolling the mobile device 320 with the endpoint management server 330 at Block 504. A calendar app 322 is downloaded from the endpoint management server 330 at Block 506. The calendar app 322 is used to schedule a meeting between a user of the mobile device 320 and a host at a physical workplace 310. The endpoint management server 330 is notified at Block 508 in response to the mobile device 320 entering into a geo-fence 312 of the physical workplace 310. The mobile device 320 receives from the endpoint management server 330 an access code 324 at Block 510, and displays the access code 324 at Block 512 to provide access by the visitor to the physical workplace 310. The method ends at Block 514.

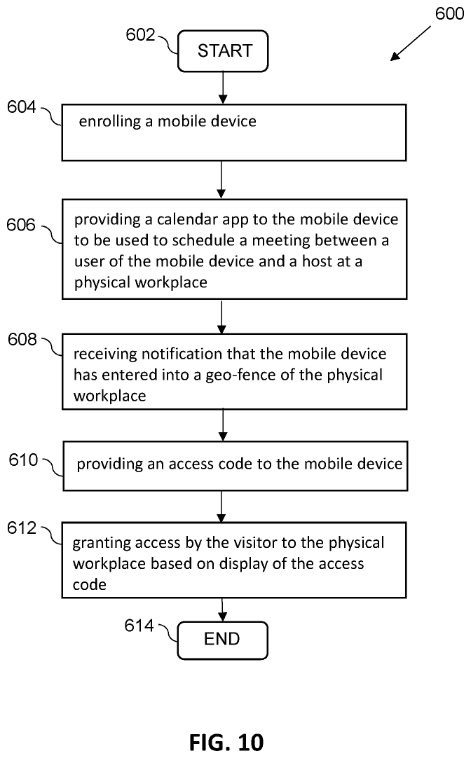

Referring now to FIG. 10, a flowchart 600 illustrating a method for operating the endpoint management server 330 will be discussed. From the start (Block 602), the method includes enrolling the mobile device 320 at Block 604, and providing a calendar app 322 to the mobile device 320 at Block 606 to be used to schedule a meeting between a user of the mobile device 320 and a host at a physical workplace 310. Notification is received at Block 608 that the mobile device 320 has entered into a geo-fence 312 of the physical workplace 310. An access code 324 is provided to the mobile device 320 at Block 610, and access by the visitor to the physical workplace 310 is granted at Block 612 based on display of the access code 324. The method ends at Block 614.

As will be appreciated by one of skill in the art upon reading the above disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

That which is claimed:

1. A mobile device comprising:
a memory and a processor coupled to said memory and configured to perform the following:
enroll the mobile device with an endpoint management server,
download a calendar app from the endpoint management server, with the calendar app being used to schedule a meeting between a user of the mobile device and a host at a physical workplace,
notify the endpoint management server in response to the mobile device entering into a geo-fence of the physical workplace,
receive from the endpoint management server an access code, and
display the access code to provide access by the user to the physical workplace.

2. The mobile device according to claim 1 wherein said processor is further configured to receive an invite from the endpoint management server to initiate the enrollment of the mobile device with the endpoint management server.

3. The mobile device according to claim 1 wherein the calendar app comprises a containerized calendar app under control of the endpoint management server.

4. The mobile device according to claim 3 wherein control of the containerized calendar app comprises the endpoint management server at least partially enabling and disabling the containerized calendar app based on a geo-location of the mobile device with respect to the geo-fence of the physical workplace.

5. The mobile device according to claim 1 wherein said processor is further configured to receive a geo-fence policy from the endpoint management server, with the geo-fence policy providing boundaries of the geo-fence of the physical workplace.

6. The mobile device according to claim 1 wherein said processor is further configured to perform the following:
determine a current geo-location of the mobile device; and
compare the current geo-location of the mobile device to the geo-fence of the physical workplace to determine that the mobile device has entered into the geo-fence.

7. The mobile device according to claim 1 wherein the access code is received by said processor after the endpoint management server validates that the user is at the physical workplace on a scheduled day and time for the meeting.

8. The mobile device according to claim 7 wherein the said processor is further configured to use biometrics of the user to authenticate the user with the endpoint management server before displaying the access code.

9. The mobile device according to claim 1 wherein the access code comprises at least one of a QR code and an animated QR code.

10. A method comprising:
enrolling a mobile device with an endpoint management server;
downloading a calendar app from the endpoint management server, with the calendar app being used to schedule a meeting between a user of the mobile device and a host at a physical workplace;
notifying the endpoint management server in response to the mobile device entering into a geo-fence of the physical workplace;
receiving from the endpoint management server an access code; and
displaying the access code on the mobile device to provide access by the user to the physical workplace.

11. The method according to claim 10 further comprising receiving an invite from the endpoint management server to initiate the enrollment of the mobile device with the endpoint management server.

12. The method according to claim 10 wherein the calendar app comprises a containerized calendar app under control of the endpoint management server.

13. The method according to claim 10 further comprising receiving a geo-fence policy from the endpoint management server, with the geo-fence policy providing boundaries of the geo-fence of the physical workplace.

14. The method according to claim 10 further comprising:
determining a current geo-location of the mobile device; and
comparing the current geo-location of the mobile device to the geo-fence of the physical workplace to determine that the mobile device has entered into the geo-fence of the physical workplace.

15. The method according to claim 12 wherein the access code is received after the endpoint management server validates that the user is at the physical workplace on a scheduled day and time for the meeting.

16. The method according to claim 15 further comprising using biometrics of the user to authenticate the user with the endpoint management server before displaying the access code.

17. An endpoint management server comprising:
a memory and a processor coupled to said memory and configured to perform the following:
enroll a mobile device,
provide a calendar app to the mobile device, with the calendar app being used to schedule a meeting between a user of the mobile device and a host at a physical workplace,
receive notification that the mobile device has entered into a geo-fence of the physical workplace,
provide an access code to the mobile device, and
grant access by the user to the physical workplace based on display of the access code.

18. The endpoint management server according to claim 17 wherein said processor is further configured to provide an invite to the mobile device to initiate the enrollment of the mobile device.

19. The endpoint management server according to claim 17 wherein the calendar app comprises a containerized calendar app under control of said processor.

20. The endpoint management server according to claim 17 wherein said processor is further configured to provide a geo-fence policy to the mobile device, with the geo-fence policy providing boundaries of the geo-fence.

21. The endpoint management server according to claim 17 wherein said processor is further configured to validate that the user is at the physical workplace on a scheduled day and time for the meeting before providing the access code to the mobile device, and

22. The endpoint management server according to claim 17 wherein said processor receives user authentication from the mobile device before the access coded is to be displayed on the mobile device, with the user authentication being based on biometrics of the user.
